(19) United States
(12) Patent Application Publication
(10) Pub. No.: US 2004/0130617 A1
(43) Pub. Date: Jul. 8, 2004

(54) Vehicle mounted audio/video player unit

(76) Inventor: Thomas Tseng, La Habra Heights, CA (US)

Correspondence Address: JOE NIEH, 18760 E. AMAR ROAD #204, WALNUT, CA, 91789, US

(21) Appl. No.: 10/336,571

(22) Filed: Jan. 3, 2003

(51) Int. Cl. H04N 7/18

(52) U.S. Cl. 348/61

(57) ABSTRACT

An audio/video source that is mounted on the roof inside an automobile is disclosed. The audio/video source may be an AM/FM radio, an AM/FM radio with cassette player, an AM/FM radio with CD player, a DVD player, a video game console, or any other suitable audio/video source. The audio/video source may be attached to the interior roof of an automobile by bolts, sheet metal screws, brackets, or any other suitable means. The roof mounted audio/video source will allow the rear seat passengers to fully and easily control their desired source of entertainment during their occupancy of the automobile without disturbing the driver or the front sear passenger.

### BACKGROUND

1. Field of Invention

The present invention relates generally to an audio/video source that is mounted inside and on the roof a vehicle. More specifically the present invention is an audio/video player unit that is mounted on the interior roof of an automobile.

2. Description of Related Art

Modern vehicles are not simply a means of transportation. Automobiles not only transport people from one place to another but also provide entertainment to the occupants during transit. The entertainment source may be in the form of a simple AM/FM radio, an AM/FM radio with cassette player, an AM/FM radio with CD player, a CD player, a DVD player, a video game console, or any other audio/video source.

Generally the entertainment source is installed inside the dashboard within the center console and within easy reach of the driver and front passenger of an automobile. The bulkier units such as a CD changer and a video cassette player may be installed inside the trunk of an automobile with the controls installed on the center console of the dash board. The rear seat passengers generally cannot reach and control the entertainment source from the back seat of the automobile with the exception of some very high end luxury automobiles that have additional controls at the rear seats. Therefore, the rear seat passengers are generally passive listeners/viewers due to the lack of control of the entertainment source. Furthermore, all occupants of the automobile must listen to or view the same source of entertainment.

### SUMMARY OF THE INVENTION

The present invention is an audio/video source that is mounted on the roof inside an automobile. The audio/video source may be an AM/FM radio, an AM/FM radio with cassette player, an AM/FM radio with CD player, a DVD player, a video game console, or any other suitable audio/video source. The audio/video source may be attached to the interior roof of an automobile by bolts, sheet metal screws, brackets, or any other suitable means. The roof mounted audio/video source will allow the rear seat passengers to fully and easily control their desired source of entertainment during their occupancy of the automobile without disturbing the driver or the front sear passenger.

### BRIEF DESCRIPTION OF THE DRAWINGS

FIG. 1 shows a DVD player suitable for mounting on the interior roof of an automobile.

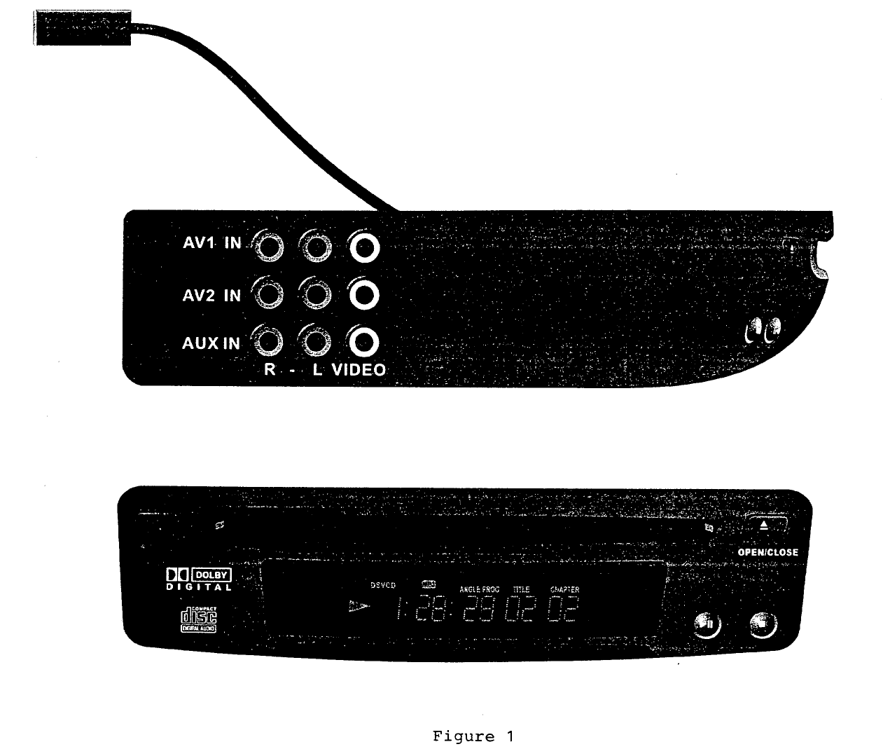

FIG. 2 shows the DVD player mounted on the interior roof of an automobile.

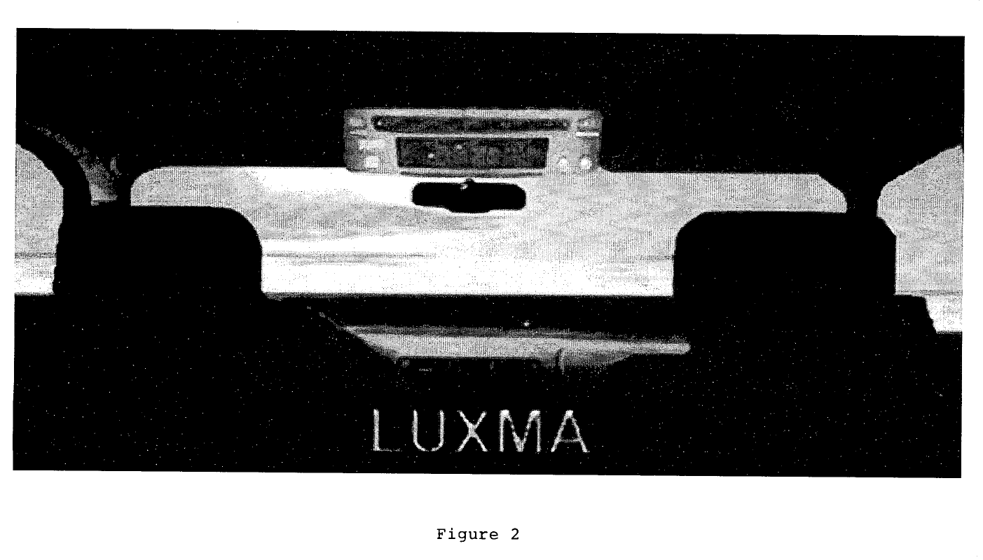

### DETAILED DESCRIPTION OF THE PREFERRED EMBODIMENT

A compact audio/video source is attached to the roof inside an automobile. The audio/video source may be an AM/FM radio, an AM/FM radio with cassette player, an AM/FM radio with CD player, a DVD player, a video game console, or any other suitable audio/video source. The audio/video source may be attached to the interior roof of an automobile by bolts, sheet metal screws, brackets, or any other suitable means. The roof mounted audio/video source will allow the rear seat passengers to fully and easily control their desired source of entertainment during their occupancy of the automobile without disturbing the driver or the front sear passenger.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A vehicle mounted audio/video player unit comprising an audio/video source attached to the interior roof of the vehicle.

2. A vehicle mounted audio/video player unit as in claim 1, wherein the audio/video source is an AM/FM radio.

3. A vehicle mounted audio/video player unit as in claim 1, wherein the audio/video source is an AM/FM radio with cassette player.

4. A vehicle mounted audio/video player unit as in claim 1, wherein the audio/video source is an AM/FM radio with CD player.

5. A vehicle mounted audio/video player unit as in claim 1, wherein the audio/video source is a CD player.

6. A vehicle mounted audio/video player unit as in claim 1, wherein the audio/video source is a DVD player.

7. A vehicle mounted audio/video player unit as in claim 1, wherein the audio/video source is a video cassette player.

8. A vehicle mounted audio/video player unit as in claim 1, wherein the audio/video source is a video game console.

9. A vehicle mounted audio/video player unit as in claim 1, wherein the audio/video source is bolted onto the interior roof of the vehicle.

10. A vehicle mounted audio/video player unit as in claim 1, wherein the audio/video source is attached to the interior roof of the vehicle with machine screws.

11. A vehicle mounted audio/video player unit as in claim 1, wherein the audio/video source is attached to the interior roof of the vehicle with suitable mounting brackets.
